(19) United States
(12) Patent Application Publication
(10) Pub. No.: US 2012/0235777 A1
(43) Pub. Date: Sep. 20, 2012

(54) ELECTROMAGNETIC ACTUATING DEVICE

(75) Inventors: Harald Elendt, Altendorf (DE); Andreas Nendel, Hessdorf (DE)

(73) Assignee: SCHAEFFLER TECHNOLOGIES AG & CO. KG, Herzogenaurach (DE)

(21) Appl. No.: 13/512,982

(22) PCT Filed: Nov. 24, 2010
(86) PCT No.: PCT/EP2010/068071

§ 371 Date: May 31, 2012

(30) Foreign Application Priority Data
Dec. 2, 2009 (DE) 10 2009 056 609.0

(51) Int. Cl. H01F 7/122

(52) U.S. Cl. 335/229

(57) ABSTRACT

An electromagnetic actuating device (1), having a housing (10), two actuating pins (8, 9), which are mounted in the housing so as to be movable independently of each other between a retracted non-working position and an extended working position, and an electrically energizable magnetic coil device for actuating the actuating pins and two permanent magnets (26, 27) which interact with the actuating pins with respect to the actuation. The permanent magnets are oriented so as to have opposite polarizations in the movement direction and are together associated with a stationary core region (28) of the magnetic coil device. The magnetic coil device is designed to generate a magnetic field, the direction of action of which reverses, dependent on the energizing of said magnetic coil device, wherein the magnetic field attracts the first permanent magnet and repels the second permanent magnet and vice versa. This is achieved in that the magnetic coil device should have two magnetic coils (29, 30) that are energizable independently of each other such that the magnetic field is generated with a first direction of action when the first magnetic coil is energized, and the magnetic field is generated with a second, reversed direction of action when the second magnetic coil is energized.

### BACKGROUND

The present invention relates to an electromagnetic actuating device comprising a housing, two actuating pins mounted in the housing so as to be movable independently of each other between a non-working position retracted into the housing and a working position extended from the housing, and a magnetic coil device to which electric current can be supplied for actuating the actuating pins as well as two permanent magnets that interact with the actuating pins with respect to the actuation, the permanent magnets having double-pole magnetization and being oriented so as to have opposite polarizations in the movement direction, and being together associated with a stationary core region of the magnetic coil device. The magnetic coil device is designed to generate a magnetic field at the core region whose direction of action reverses as a function of the supplying of current to said magnetic coil device, the magnetic field attracting the first permanent magnet and repelling the second permanent magnet and vice versa.

Such an actuating device is particularly suitable for adjusting variable-stroke valve drives of internal combustion engines, whose operating design is known for example from DE 10 2004 021 376 A1. The variability of the stroke of this valve drive is based on a cam part having two cams situated thereon immediately adjacent to one another, whose different opening paths are selectively transmitted to a gas exchange valve by a conventionally rigidly fashioned cam follower. In order to set these opening paths in a manner dependent on the operating point, the cam part is situated in a rotationally fixed but longitudinally displaceable fashion on a carrier shaft, and has two spiral-shaped displacement grooves that run in opposite directions to one another in which the end segments of the actuating pins of both actuating devices are alternately coupled (with only one actuating pin). While the axial run of the displacement groove engaged with the associated actuating pin causes the cam part to move from the one cam position to the other cam position in self-guiding fashion and in a manner true to the camshaft angle, the radial run of each displacement groove is fashioned such that it becomes increasingly flatter toward the end of the displacement process, and shifts the currently engaged actuating pin from its working position back to the non-working position.

In the valve drive proposed in DE 196 11 641 C1, having three adjacent cams and two actuating pins situated with a small distance from one another, it appears to be useful to integrate the actuating pins in a common housing.

WO 03/021612 A1 proposes an actuating device whose actuation is based on the interplay of a magnetic coil with a permanent magnet fastened on the actuating pin. On the basis of the magnetic attractive force thereof, the actuating pin, to which a spring force is applied in the direction of extension, adheres to the currentless magnetic coil. In order to release the actuating pin from this non-working position, it is necessary merely to provide a pulsed supply of current to the magnetic coil in order to overcome the magnetic attractive force of the permanent magnet, the actuating pin being accelerated in the direction of the working position not only by the force of the spring device but also by the force of a magnetic repelling effect between the permanent magnet and the magnetic coil supplied with current.

A development of this design is disclosed in DE 20 2008 008 142 U1. Here, the actuating pin is held on a permanent magnet only by the magnetic attractive force, so that the mutually eccentric situation of actuating pins and permanent magnets/magnetic coils enables a compact construction of the regulating device having two or three selectively controllable actuating pins in a common housing.

An actuating device of the type named above also results from DE 10 2009 010 949 A1 (which has not been previously published). The actuating device proposed there has a magnetic coil that is supplied with current in reversible fashion, i.e. with opposed directions of current flow, for the purpose of reversing the magnetic field action. As a function of the magnetic field direction, one of the two actuating pins is actuated in the direction of extension, while the other actuating pin remains in its retracted non-working position. The current supply device required for the electrical controlling of the regulating device—in the preferred case of application of the named variable-stroke valve drive of an internal combustion engine, this is usefully the engine control device—must be provided with a corresponding current direction reversing circuit, for example in the form of a so-called H-bridge. Such a circuit is however not provided as standard equipment in engine control devices, and requires an expensive modification of the control device.

The same problem is found in the actuating device known from WO 2009/018919 A1, having reversible supply of current to the magnetic coil.

### SUMMARY

The present invention is based on the object of developing an actuating device of the type noted above in such a way that the above-noted disadvantages are removed using simple means. In particular, the actuating device should be compatible with conventional control devices not having a reversal of the direction of current, or should require only a slight modification of the control device in order to be capable of operation in the sense of the reversible magnetic field action.

This object is achieved by the features of the invention. Accordingly, the object is achieved in that the magnetic coil device has two magnetic coils capable of being supplied with current independent of one another such that when the first magnetic coil is supplied with current the magnetic field is produced having a first direction of action and when the second magnetic coil is supplied with current the magnetic field is produced having a reversed, second direction of action.

Compared to the prior art cited above, therefore, a supply of current to the magnetic coil device with reversible direction of flow of current is not required. The reversal of the direction of action of the magnetic field at the stationary core region is rather produced in that the actuating device is provided with two magnetic coils that are independent of one another and can be supplied with current selectively. The opposed orientation of the permanent magnetic poles then has the result, as a function of the magnetic coil supplied with current at that moment, that the same magnetic field attracts one permanent magnet and repels the other permanent magnet. This force action is reversed when current is supplied to the respective other magnetic coil.

The magnetic coils are preferably disposed successively in the direction of movement, i.e. in an axial series circuit around the core region.

In a preferred development of the present invention, each of the actuating pins should have assigned to it a spring device that applies force to the actuating pin in the direction of extension, a detent mechanism, and a locking pin that works together with the actuating pin by means of the detent mechanism, said pin holding the associated actuating pin in the non-working position when the detent mechanism is locked, and being capable of being displaced relative to said actuating pin in the direction of movement. The head segments of the locking pins facing away from the actuating pins are each provided with one of the permanent magnets. The magnetic field produced when current is supplied to one of the magnetic coils displaces one of the locking pins in the direction of retraction in order to release the associated detent mechanism, and applies force to the other locking pin in the direction of extension in order to lock the associated detent mechanism.

Here, the locking pin connected to the first permanent magnet moves in the direction of the core region, i.e. in the direction of retraction of the associated actuating pin, which, given the now-released detent mechanism, moves into its working position due to the force of the spring device. In contrast, the locking pin connected to the second permanent magnet and the associated actuating pin remain idle with a locked detent mechanism.

When the respectively other magnetic coil is supplied with current, the action of the magnetic field reverses, so that now the second permanent magnet is attracted while the first permanent magnet is repelled. The beginning point for this is again the state in which the two actuating pins are held in their non-working positions by the detent mechanisms. Analogously, the second actuating pin now moves into its working position, while the first actuating pin remains in its non-working position.

Moreover, when the head segments of the locking pins come to be seated on the core region, the permanent magnets should move at a distance from the core region. This is usefully achieved constructively in that the head segments of the locking pins run so as to be raised relative to the permanent magnets. Through this measure, the force action of the permanent magnets, which increases exponentially in the area close to the core region, can be limited to a degree such that when the magnetic coils are not supplied with current a sufficient force acts that resets the locking pins. This force action should usefully be exerted by further spring devices that apply force to the locking pins in the direction of extension.

In a preferred embodiment, the detent mechanisms are to be formed by the following features:
a longitudinal bore made in the actuating pin for receiving the locking pin and one or more cross-bores intersecting the longitudinal bore,
a first support surface formed on the locking pin and a second support surface formed in the housing, at least one of the support surfaces extending at an incline relative to the direction of travel,
and locking bodies that are movably situated in the cross-bores and that in the non-working position are clamped between the support surfaces.

With the use of such a detent mechanism, based on a positive connection or frictional connection, only small acting surfaces are required to hold the associated actuating pin securely in its non-working position against the force of the spring device. In contrast to the holding forces produced in this way, the required forces for releasing the detent mechanism are many times smaller, because in addition to the force of the additional spring device acting on the locking pin, only the frictional forces acting between the locking bodies and the support surfaces have to be overcome.

The locking body or bodies are preferably fashioned as balls, obtainable as an extremely economical mass product of rolling body manufacture. Three balls and three cross-bores distributed uniformly around the circumference of the actuating pin can be provided. This arrangement is advantageous relative to only one ball insofar as either, given identical dimensioning of the balls, greater holding forces can be produced, or, given smaller dimensioning of the balls—corresponding to a further reduced space requirement of the detent mechanism—the holding force of only one ball, which may already be adequate, can be produced. On the other hand, the arrangement of the balls distributed around the circumference at intervals of 120° results in a mechanically favorable centered supporting of the locking pin in the longitudinal bore of the actuating pin. Nonetheless, of course, systems are possible having only one, two, four, or more balls.

Moreover, the balls can be clamped between the support surfaces in self-locking fashion, such that the support surfaces have a distance from one another that is constant or that becomes smaller in the direction of retraction. For example, the second support surface can run parallel to the direction of movement of the actuating pin, and can be part of an easily manufactured continuous cylindrical longitudinal guide for the actuating pin. In the constructive design of the support surfaces, of course both the forces of the spring devices and the conditions of friction at the points of contact between the balls and support surfaces are to be taken into account, so that the system remains within the range of self-locking at these contacts that is required for proper functioning of the detent mechanism.

It is useful for the first support surface on the locking pin to taper radially in the direction of extension, and for the support surfaces to run parallel to one another. In the case of rotationally symmetrical support surfaces, the support surfaces are then fashioned in the shape of circular frustums. This design enables a particularly low-wear gliding or rolling contact between the balls and support surfaces when the actuating pin leaves the non-working position and returns to it.

### BRIEF DESCRIPTION OF THE DRAWINGS

Further features of the present invention result from the following description and from the Figures, which show an exemplary embodiment of an electromagnetic actuating device according to the present invention. Unless otherwise indicated, identical or functionally identical features or components are provided with identical reference numbers.

FIG. 1 shows the electromagnetic actuating device in longitudinal section, and

FIG. 2 shows a known embodiment of a variable-stroke valve drive, working together with an actuating device, of an internal combustion engine.

### DETAILED DESCRIPTION OF THE PREFERRED EMBODIMENTS

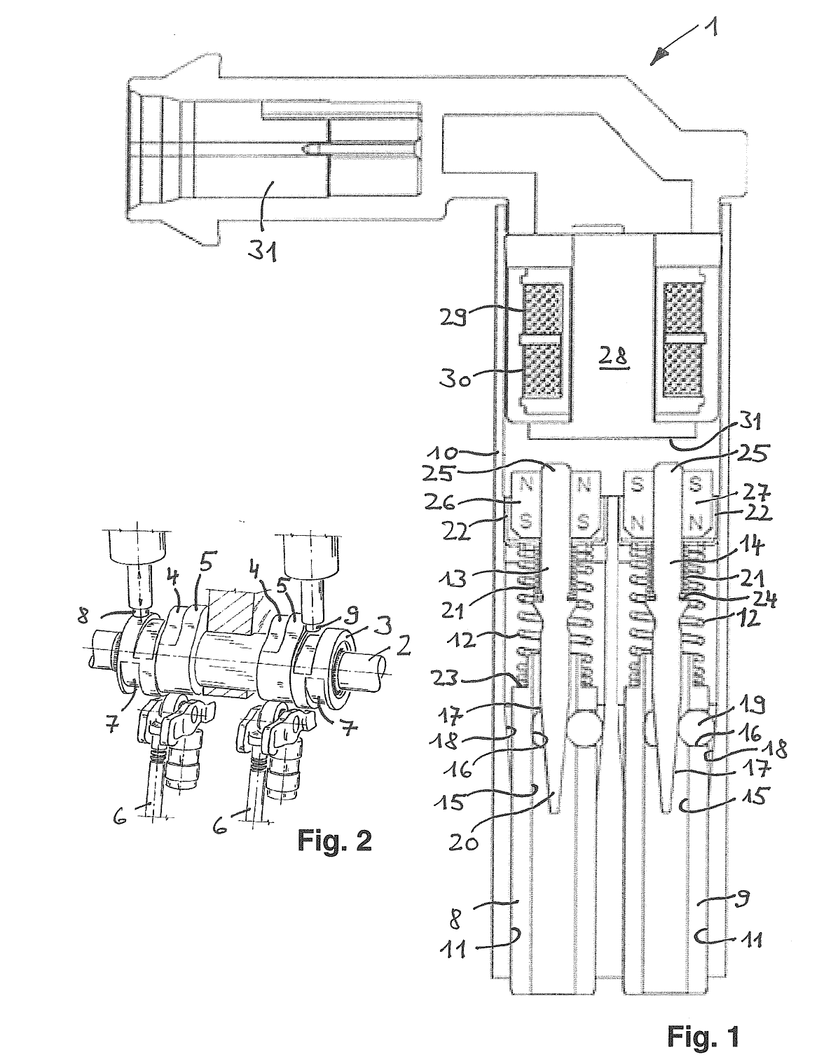

FIG. 1 discloses an exemplary embodiment of an actuating device 1 according to the present invention that is used to control a known variable-stroke valve drive of an internal combustion engine. The functional design of such a valve drive is shown in FIG. 2 and can be summarized as follows: instead of a conventionally rigidly fashioned camshaft, a carrier shaft 2 is provided having a cam part 3 situated thereon in rotationally fixed and longitudinally displaceable fashion. The cam part 3 has two groups of axially adjacent cams 4 and 5 having differing opening paths, used to actuate gas exchange valves 6 as a function of the operating point. The displacement of the cam part 3 on the carrier shaft 2 required for the selective activation of the respective cam 4 or 5 is accomplished via spiral-shaped displacement grooves 7 on the cam part 3 that differ in their orientation in a manner corresponding to the direction of displacement, and in each of which a respective actuating pin 8 or 9 is capable of coupling depending on the momentary position of the cam part 3.

The actuating device 1 is a constructive unit that can be mounted in the cylinder head of the internal combustion engine, having a housing 10 and having two actuating pins 8 and 9 situated therein and fashioned as hollow cylinders. The actuating pins 8, 9, fashioned as identical parts, are mounted in longitudinal guides 11 of the housing 10 and can be moved back and forth independently of one another between a non-working position (as shown) in which they are retracted in the housing 10 and a working position in which they are extended from the housing 10. As explained above, in the working position (not shown) the actuating pins 8, 9 engage with an associated displacement groove of a cam part in order to displace the cam part.

The actuating pins 8, 9, to which force is applied in the direction of extension by spring devices (here helical pressure springs 12), are held in the non-working position by detent mechanisms. A releasing of the detent mechanisms is accomplished by controllable locking pins 13 and 14, also fashioned as identical parts and displaceable relative to the actuating pins 8, 9 in the direction of movement thereof.

The detent mechanisms, which are identical to one another, are each fashioned by a longitudinal bore 15 running in the actuating pin 8, 9 and cross-bores 16 that intersect said longitudinal bore, by a first support surface 17 fashioned on the locking pin 13, 14 and a second support surface 18 fashioned in the housing 10, and by three locking bodies in the form of balls 19. The balls 19, situated so as to be capable of movement in the cross-bores 16 distributed uniformly on the circumference of the actuating pin 8, 9, are clamped between the support surfaces 17 and 18 in the non-working position of the actuating pin 8, 9. For this purpose, end segment 20, running in the longitudinal bore 15, of the locking pin 13, 14 tapers conically in the direction of extension of the actuating pin 8, 9, so that the first support surface 17 forms the outer casing surface of a circular frustum. The second support surface 18 in the housing 10 runs at a constant distance therefrom, and consequently forms the inner casing surface of a circular frustum.

Force is also applied in the direction of extension to each of the locking pins 13, 14 by a further spring device, here a helical pressure spring 21. Taking into account the spring forces acting on the locking pin 13, 14 and on the actuating pin 8, 9 as well as the frictional conditions at the ball-support surface contact points, the angle of inclination of the support surfaces 17, 18 relative to the direction of movement of the actuating pin 8, 9 is selected such that the balls 19 are clamped in self-locking fashion between the support surfaces 17, 18, thus securely fixing the actuating pin 8, 9 in the non-working position. In the present case, the angle of inclination is approximately 5°.

Concentric helical pressure springs 12, 21 are supported on the one hand on bushings 22 pressed into the housing 10, and on the other hand on circular ring-shaped end faces 23 and 24 of the actuating pins 8, 9 or of the locking pins 13, 14. In order to release the detent mechanisms, these locking pins are displaced, under the application of electromagnetic force, in the direction of retraction of the actuating pins 8, 9, and for this purpose are provided with permanent magnets 26 and 27 fastened on their head segments 25 facing away from the actuating pins 8, 9. These permanent magnets are axially magnetized in double-pole fashion, and are oriented opposite one another in the direction of travel of the actuating pins 8, 9 with regard to their north and south poles, designated N and S, and are exposed to the magnetic field of a magnetic coil device.

As essential components, the magnetic coil device has a stationary core region 28 and two magnetic coils 29 and 30 to which current can be supplied independently of one another and that are situated successively in the direction of movement of the actuating pins 8, 9, i.e. in an axial series circuit about core region 28, and that produce a reversible magnetic field whose direction of action is a function of the momentary state of current flow in the magnetic coils 29, 30. The selective supply of current to the magnetic coils 29, 30 takes place via a plug connector 31. The core region 28, which runs coaxially to the magnetic coils 29, 30, has at the side of the permanent magnets 26, 27 a shoulder that forms a flat support surface 31 for the locking pins 13, 14. A strongly adhesive supporting of the permanent magnets 26, 27 on the support surface 31 is avoided in that the head segments 25 of the locking pins 13, 14 extend so as to be raised relative to the permanent magnets 26, 27, and these always have a corresponding minimum distance from the support surface 31.

The manner of functioning of the actuating device 1 is as follows: the supply of current to the first magnetic coil 29 (second magnetic coil 30 remains without current here) produces a magnetic field in a first direction of action with south pole on the support surface 31 of the core region 28, so that the first permanent magnet 26, with its N-S pole orientation, is attracted and the second permanent magnet 27, with its S-N pole orientation, is repelled. While repelled, the second permanent magnet 27, the associated locking pin 14, and consequently also the associated actuating pin 9 remain at rest when the detent mechanism is locked, the locking pin 13, attracted by the first permanent magnet 26, moves in the direction of retraction up to support surface 31. The associated detent mechanism is released here in that the clamping effect of the balls 19 relative to the support surfaces 17, 18 is canceled. While the balls 19 follow the inclination of the second support surface 18 in the housing 10, moving radially inwards into the cross-bores 16, the actuating pin 8 is driven into its working position by the force of the helical pressure spring 12. The first magnetic coil 29 is thereupon switched to be without current, so that the attracted locking pin 13 returns to its initial position due to the force of the helical pressure spring 21.

As mentioned above, the actuating pin 8, which engages with the cam part, is pushed back into its non-working position by the radially raised run-out region of the displacement groove, and is again locked in this position. This takes place in that the balls 19 follow the inclined run of the first support surface 17 on the locking pin 13, are displaced radially outward into the cross-bores 16, and are clamped in self-locking fashion between the support surfaces 17, 18.

While the actuating pin 8 subsequently remains in its locked non-working position, the actuation of the other actuating pin 9 is introduced in that the second magnetic coil 30 is now supplied with current, while the first magnetic coil 29 remains without current. The reversed direction of action of the now-resulting magnetic field, with north pole at the support surface 31 of the core region 28, repels the first permanent magnet 26, with its N-S pole orientation, and attracts the second permanent magnet 27, with its S-N pole orientation. The further course of actuation of the other actuating pin 9 takes place in a manner identical to that explained above for the case of the actuating pin 8.

### LIST OF REFERENCE CHARACTERS

1 actuating device
2 carrier shaft
3 cam part
4 cam
5 cam
6 gas exchange valve
7 displacement groove
8 actuating pin
9 actuating pin
10 housing
11 longitudinal guide
12 spring device/helical pressure spring
13 locking pin
14 locking pin
15 longitudinal bore
16 cross-bore
17 first support surface
18 second support surface
19 locking body/ball
20 end segment of the locking pin
21 additional spring device/helical pressure spring
22 bushing
23 end face of the actuating pin
24 end face of the locking pin
25 head segment of the locking pin
26 permanent magnet
27 permanent magnet
28 core region
29 first magnetic coil
30 second magnetic coil
31 support surface of the core region

1. An electromagnetic actuating device comprising a housing, two actuating pins mounted in the housing so as to be movable independently of each other between a non-working position in which they are retracted into the housing and a working position in which they are extended from the housing, and a magnetic coil device to which electric current can be is supplied in order to actuate the actuating pins as well as two permanent magnets that interact with the actuating pins with respect to the actuation, the permanent magnets having double-pole magnetization and being oriented so as to have opposite polarizations in a direction of movement, and being together associated with a stationary core region of the magnetic coil device, the magnetic coil device being designed to generate a magnetic field at the stationary core region having a direction of action that reverses as a function of a supply of current to said magnetic coil device, the magnetic field attracting the first permanent magnet and repelling the second permanent magnet a and vice versa, the magnetic coil device has two magnetic coils that are supplyable with current independently of each other, and the magnetic field is generated with a first direction of action when the first magnetic coil is supplied with the current, and the magnetic field is generated with a second, reversed direction of action when the second magnetic coil is supplied with the current.

2. The actuating device as recited in claim 1, wherein that the magnetic coils are situated successively in the direction of movement.

3. The actuating device as recited in claim 1, wherein the actuating pins each have assigned to them a spring device that applies force to the actuating pin in a direction of extension, a detent mechanism, and a locking pin that works together with the actuating pin via the detent mechanism, said locking pin holding the associated actuating pin in the non-working position when the detent mechanism is locked, and being displaceable relative to said actuating pin in the direction of movement, head segments, facing away from the actuating pins, of the locking pins each being provided with one of the permanent magnets, and the magnetic field produced when the current is supplied to one of the magnetic coils is adapted to displace one of the locking pins in the direction of retraction in order to release the associated detent mechanism, and is adapted to apply force to the other of the locking pins in the direction of extension in order to lock the associated detent mechanism.

4. The actuating device as recited in claim 3, wherein when the head segments of the locking pins are supported on the core region, the permanent magnets run at a distance from said core region.

5. The actuating device as recited in claim 4, wherein that the head segments of the locking pins run so as to be raised relative to the permanent magnets.

6. The actuating device as recited in claim 3, wherein the detent mechanisms each comprise
a longitudinal bore made in each of the actuating pins for receiving the locking pin, and one or more cross-bores intersecting the longitudinal bore,
a first support surface formed on the locking pin and a second support surface formed in the housing, at least one of the support surfaces running at an incline relative to the direction of travel,
and locking bodies that are movably situated in the cross-bores and that in the non-working position are clamped between the support surfaces.

7. The actuating device as recited in claim 6, wherein three of the locking bodies fashioned as balls and three of the cross-bores distributed uniformly around a circumference of the actuating pin are provided.

8. The actuating device as recited in claim 7, wherein the balls are clamped in self-locking fashion between the support surfaces, the support surfaces having a distance from one another that is constant or that becomes smaller in the direction of retraction.

9. The actuating device as recited in claim 8, wherein the first support surface tapers radially in the direction of extension, and the support surfaces run parallel to one another.

10. The actuating device as recited in claim 9, wherein the support surfaces a circular frustum shape.
